(19) United States
(12) Patent Application Publication
(10) Pub. No.: US 2026/0033531 A1
(43) Pub. Date: Feb. 5, 2026

(54) ATOMISATION MODULE AND LIQUID CONTAINER FOR A HOOKAH

(71) Applicant: SHAHEEN INNOVATIONS HOLDING LIMITED, Abu Dhabi (AE)

(72) Inventors: Mohammed Alshaiba Saleh Ghannam Almazrouei, Abu Dhabi (AE); Dinil Divakaran, Abu Dhabi (AE); Clement Lamoureux, Abu Dhabi (AE); Nveed Chaudhary, Abu Dhabi (AE); Peter Lomas, Wirral (GB)

(21) Appl. No.: 19/279,883

(22) Filed: Jul. 24, 2025

Related U.S. Application Data
(60) Provisional application No. 63/678,870, filed on Aug. 2, 2024.

(51) Int. Cl. A24F 1/30; A24F 40/05; A24F 40/10; A24F 40/42; A24F 40/44; A24F 40/485; A24F 40/53; A24F 40/70; B05B 7/16

(52) U.S. Cl. CPC A24F 1/30; A24F 40/05; A24F 40/10; A24F 40/42; A24F 40/44; A24F 40/485; A24F 40/53; A24F 40/70; B05B 7/1693

(57) ABSTRACT

An atomisation module and liquid container for a hookah. The liquid container is releasably attachable to the atomisation module. When the liquid container is attached to the atomisation module, liquid flows out of a liquid outlet, through a liquid flow guide and into a secondary liquid chamber. A first capillary transfers the liquid to a second capillary, and an ultrasonic transducer atomises the liquid to produce a mist. When the liquid chamber is depleted of liquid, the liquid container may be detached from the atomisation module and replaced.

### CROSS-REFERENCES TO RELATED APPLICATIONS

The present application claims the benefit of priority to U.S. Provisional Patent Application No. 63/678,870, filed on 2 Aug. 2024; the contents of which are incorporated herein by reference in their entirety.

### FIELD

The present invention relates to an atomisation module and liquid container for a mist inhaler. The present invention more particularly relates to an atomisation module and liquid container for a mist inhaler which generates a mist using ultrasonic vibrations.

### BACKGROUND

The traditional hookah is a smoking device which burns tobacco leaves that have been crushed and prepared specifically to be heated using charcoal. The heat from the charcoal causes the crushed tobacco leaves to burn, producing smoke that is pulled through water in a glass chamber and to the user by inhalation. The water is used to cool the hot smoke for ease of inhalation.

Hookah use began centuries ago in ancient Persia and India. Today, hookah cafés are gaining popularity around the world, including the United Kingdom, France, Russia, the Middle East and the United States.

A typical modern hookah has a head (with holes in the bottom), a metal body, a water bowl and a flexible hose with a mouthpiece. Some new forms of electronic hookah products use a liquid containing nicotine, flavorings and other chemicals to produce smoke or vapor which is inhaled.

Electronic hookahs may have a mist generator device which includes a reservoir containing liquid to be vaporized. The liquid can sometimes leak from the reservoir and result in excessive depletion of the liquid and may also cause the liquid to unintentionally enter the user's mouth when they inhale on the mouthpiece.

The mist generator devices of some electronic hookahs may employ structural features to mitigate leakage, but this can result in complex construction which adds cost and time to the manufacturing process of an electronic hookah. Additionally, some structural modifications may negatively impact the vaporization of the liquid and airflow of the electronic hookah.

Thus, a need exists in the art for an improved hookah device which seeks to address at least some of the problems described herein.

The present invention seeks to provide an improved atomisation module and liquid container for a mist inhaler.

### BRIEF DESCRIPTION OF THE INVENTION

The present invention provides an atomisation module and liquid container as claimed in claim 1, a hookah as claimed in claim 16 and a hookah as claimed in claim 17. The present invention also provides preferred embodiments as claimed in the dependent claims.

### REPRESENTATIVE FEATURES

Representative features are set out in the following clauses, which stand alone or may be combined, in any combination, with one or more features disclosed in the text and/or drawings of the specification.
1. An atomisation module and liquid container for a mist inhaler, the atomisation module and liquid container comprising: a liquid container incorporating: a liquid container housing having an air inlet, a liquid outlet and a liquid container attachment; a liquid chamber within the liquid container housing, the liquid chamber being in fluid communication with the air inlet and the liquid outlet, the liquid chamber containing a liquid to be atomised; an air seal which seals the air inlet; a liquid seal which seals the liquid outlet; and an atomisation module incorporating: an atomisation module housing having a first portion and a second portion; a sonication chamber; a sonicator cover which is attached to the second portion of the atomisation module housing, the sonication chamber being formed between part of the sonicator cover and part of the second portion of the atomisation module housing, wherein the sonicator cover incorporates a mist outlet; a secondary liquid chamber; a secondary liquid chamber cover which is attached to the first portion of the atomisation module housing, the secondary liquid chamber being formed between part of the secondary liquid chamber cover and part of the first portion of the atomisation module housing; an atomisation module attachment provided on the secondary liquid chamber cover, the atomisation module attachment being configured to releasably attach to the liquid container attachment to enable the liquid container to be releasably attached to the atomisation module; a liquid flow guide provided on the secondary liquid chamber cover, the liquid flow guide incorporating: a liquid container opener which is configured to pierce the liquid seal to open the liquid outlet and extend through the liquid outlet at least party into the liquid chamber when the liquid container is attached to the atomisation module; and a liquid flow aperture which is configured to receive the liquid from the liquid chamber when the liquid container is attached to the atomisation module, wherein the liquid flow guide provides a liquid flow path from the liquid flow aperture to the secondary liquid chamber when the liquid container is attached to the atomisation module; the atomisation module further incorporating: a sonicator assembly provided within the sonication chamber, the sonicator assembly having an ultrasonic transducer; a first capillary having a first portion which is positioned in the secondary liquid chamber and a second portion which is positioned in the sonication chamber; and a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary, wherein, when the liquid container is attached to the atomisation module, the liquid flows out of the liquid outlet, through the liquid flow guide and into the secondary liquid chamber, and the first capillary transfers the liquid to the second capillary, and the ultrasonic transducer atomises the liquid to produce a mist, and wherein when the liquid chamber is depleted of liquid, the liquid container may be detached from the atomisation module and replaced.
2. The atomisation module and liquid container of clause 1, wherein the atomisation module further comprises a capillary element guide surface provided on the first portion of the atomisation module housing, the capillary element guide surface being angled to facilitate a flow of the liquid from the secondary liquid chamber to the sonication chamber.
3. The atomisation module and liquid container of clause 1 or clause 2, wherein the second capillary has a lower capillarity than the first capillary.
4. The atomisation module and liquid container of any one of the preceding clauses, wherein the atomisation module comprises a resiliently deformable compression body configured to apply a biasing force to bias the second portion of the first capillary element against the second capillary and bias the second capillary against the ultrasonic transducer.
5. The atomisation module and liquid container of clause 4, wherein the resiliently deformable compression body comprises a compression body adjustment arrangement which may be manipulated to adjust the biasing force applied by the resiliently deformable compression body.
6. The atomisation module and liquid container of any one of the preceding clauses, wherein the atomisation module further comprises a secondary tank seal which contacts the first capillary and seals the secondary liquid chamber outlet.
7. The atomisation module and liquid container of any one of the preceding clauses, wherein the liquid container opening arrangement comprises one of a conical member and a needle which is configured to pierce the liquid seal as the liquid container is attached to the atomisation module.
8. The atomisation module and liquid container of any one of the preceding clauses, wherein the liquid container opening arrangement further comprises a liquid collector configured to collect liquid which flows out from the liquid container and before the liquid flows into the secondary liquid chamber.
9. The atomisation module and liquid container of any one of the preceding clauses, wherein the liquid container further comprises an interior liquid guide surface which is angled to form a funnel portion which reduces a cross-section area of the liquid chamber towards the liquid outlet.
10. The atomisation module and liquid container of any one of the preceding clauses, wherein the atomisation module is configured to be coupled to a driver device and wherein the atomisation module further comprises a sonicator electrical contact arrangement which is connected electrically to the sonicator assembly, the sonicator electrical contact arrangement being configured to receive an electrical drive signal from the driver device and to communicate the electrical drive signal to the sonicator assembly to drive the ultrasonic transducer.
11. The atomisation module and liquid container of any one of the preceding clauses, wherein the liquid container comprises an identification arrangement incorporating: an integrated circuit having a memory which stores a unique identifier for the liquid container.
12. The atomisation module and liquid container of any one of the preceding clauses, wherein one of the liquid container attachment and the atomisation module attachment comprises a magnet and the other of the liquid container attachment and the atomisation module attachment comprises a ferromagnetic material such that the liquid container attachment and the atomisation module attachment couple magnetically to one another.
13. The atomisation module and liquid container of any one of the preceding clauses, wherein at least one of the secondary liquid chamber cover and the sonicator cover are ultrasonically welded to the atomisation module housing.
14. The atomisation module and liquid container of any one of the preceding clauses, wherein the sonicator assembly further comprises: a sonicator case surrounding at least part of a periphery of the ultrasonic transducer and, the sonicator case being in electrical contact with a first electrical contact on the ultrasonic transducer; a sonicator holder attached to the sonicator case; a connection pin having an end which is in electrical contact with a second electrical contact on the ultrasonic transducer; and a sleeve electrically insulating the connection pin from the sonicator holder.
15. The atomisation module and liquid container of clause 14, wherein the end of the connection pin is substantially planar.
16. A mist inhaler comprising: the atomisation module and liquid container of any one of the preceding clauses; an AC drive signal generator coupled electrically to the ultrasonic transducer to drive the ultrasonic transducer with an AC drive signal to vibrate the ultrasonic transducer and atomise the liquid carried by the second capillary to generate the mist; and a mouthpiece coupled to the mist outlet to enable the mist to flow out through the mist outlet and the mouthpiece for inhalation by a user.
17. An atomisation module for a mist inhaler, the atomisation module comprising: an atomisation module housing having a first portion and a second portion; a sonication chamber; a sonicator cover which is attached to the second portion of the atomisation module housing, the sonication chamber being formed between part of the sonicator cover and part of the second portion of the atomisation module housing, wherein the sonicator cover incorporates a mist outlet; a secondary liquid chamber; a secondary liquid chamber cover which is attached to the first portion of the atomisation module housing, the secondary liquid chamber being formed between part of the secondary liquid chamber cover and part of the first portion of the atomisation module housing; an atomisation module attachment provided on the secondary liquid chamber cover, the atomisation module attachment being configured to releasably attach to a liquid container attachment to enable a liquid container to be releasably attached to the atomisation module; a sonicator assembly provided within the sonication chamber, the sonicator assembly having an ultrasonic transducer; a first capillary having a first portion which is positioned in the secondary liquid chamber and a second portion which is positioned in the sonication chamber; and a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary.
18. A liquid container for a mist inhaler, the liquid container comprising: a liquid container housing having an air inlet, a liquid outlet and a liquid container attachment; a liquid chamber within the liquid container housing, the liquid chamber being in fluid communication with the air inlet and the liquid outlet, the liquid chamber containing a liquid to be atomised; an air seal which seals the air inlet; and a liquid seal which seals the liquid outlet.
19. An atomisation module and liquid container for a hookah, the atomisation module and liquid container comprising: a liquid container incorporating: a liquid container housing having an air inlet, a liquid outlet and a liquid container attachment; a liquid chamber within the liquid container housing, the liquid chamber being in fluid communication with the air inlet and the liquid outlet, the liquid chamber containing a liquid to be atomised; an air seal which seals the air inlet; a liquid seal which seals the liquid outlet; and an atomisation module incorporating: an atomisation module housing having a first portion and a second portion; a sonication chamber; a sonicator cover which is attached to the second portion of the atomisation module housing, the sonication chamber being formed between part of the sonicator cover and part of the second portion of the atomisation module housing, wherein the sonicator cover incorporates a mist outlet; a secondary liquid chamber; a secondary liquid chamber cover which is attached to the first portion of the atomisation module housing, the secondary liquid chamber being formed between part of the secondary liquid chamber cover and part of the first portion of the atomisation module housing; an atomisation module attachment provided on the secondary liquid chamber cover, the atomisation module attachment being configured to releasably attach to the liquid container attachment to enable the liquid container to be releasably attached to the atomisation module; a liquid flow guide provided on the secondary liquid chamber cover, the liquid flow guide incorporating: a liquid container opener which is configured to pierce the liquid seal to open the liquid outlet and extend through the liquid outlet at least party into the liquid chamber when the liquid container is attached to the atomisation module; and a liquid flow aperture which is configured to receive the liquid from the liquid chamber when the liquid container is attached to the atomisation module, wherein the liquid flow guide provides a liquid flow path from the liquid flow aperture to the secondary liquid chamber when the liquid container is attached to the atomisation module; the atomisation module further incorporating: a sonicator assembly provided within the sonication chamber, the sonicator assembly having an ultrasonic transducer; a first capillary having a first portion which is positioned in the secondary liquid chamber and a second portion which is positioned in the sonication chamber; and a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary, wherein, when the liquid container is attached to the atomisation module, the liquid flows out of the liquid outlet, through the liquid flow guide and into the secondary liquid chamber, and the first capillary transfers the liquid to the second capillary, and the ultrasonic transducer atomises the liquid to produce a mist, and wherein when the liquid chamber is depleted of liquid, the liquid container may be detached from the atomisation module and replaced, the atomisation module further comprising: a hookah attachment which is configured to attach the atomisation module to a hookah with the mist outlet providing a mist flow path from the atomisation module to the hookah to enable mist produced within the sonication chamber to be drawn out from the sonication chamber through the mist outlet and through the hookah for inhalation by a user.
20. The atomisation module and liquid container of clause 19, wherein the atomisation module further comprises a capillary element guide surface provided on the first portion of the atomisation module housing, the capillary element guide surface being angled to facilitate a flow of the liquid from the secondary liquid chamber to the sonication chamber.
21. The atomisation module and liquid container of clause 19 or clause 20, wherein the second capillary has a lower capillarity than the first capillary.
22. The atomisation module and liquid container of any one of clauses 19 to 21, wherein the atomisation module comprises a resiliently deformable compression body configured to apply a biasing force to bias the second portion of the first capillary element against the second capillary and bias the second capillary against the ultrasonic transducer.
23. The atomisation module and liquid container of clause 22, wherein the resiliently deformable compression body comprises a compression body adjustment arrangement which may be manipulated to adjust the biasing force applied by the resiliently deformable compression body.
24. The atomisation module and liquid container of any one of clauses 19 to 23, wherein the atomisation module further comprises a secondary tank seal which contacts the first capillary and seals the secondary liquid chamber outlet.
25. The atomisation module and liquid container of any one of clauses 19 to 24, wherein the liquid container opening arrangement comprises one of a conical member and a needle which is configured to pierce the liquid seal as the liquid container is attached to the atomisation module.
26. The atomisation module and liquid container of any one of clauses 19 to 25, wherein the liquid container opening arrangement further comprises a liquid collector configured to collect liquid which flows out from the liquid container and before the liquid flows into the secondary liquid chamber.
27. The atomisation module and liquid container of any one of clauses 19 to 26, wherein the liquid container further comprises an interior liquid guide surface which is angled to form a funnel portion which reduces a cross-section area of the liquid chamber towards the liquid outlet.
28. The atomisation module and liquid container of any one of clauses 19 to 27, wherein the atomisation module is configured to be coupled to a driver device and wherein the atomisation module further comprises a sonicator electrical contact arrangement which is connected electrically to the sonicator assembly, the sonicator electrical contact arrangement being configured to receive an electrical drive signal from the driver device and to communicate the electrical drive signal to the sonicator assembly to drive the ultrasonic transducer.
29. The atomisation module and liquid container of any one of clauses 19 to 28, wherein the liquid container comprises an identification arrangement incorporating: an integrated circuit having a memory which stores a unique identifier for the liquid container.
30. The atomisation module and liquid container of any one of clauses 19 to 29, wherein one of the liquid container attachment and the atomisation module attachment comprises a magnet and the other of the liquid container attachment and the atomisation module attachment comprises a ferromagnetic material such that the liquid container attachment and the atomisation module attachment couple magnetically to one another.
31. The atomisation module and liquid container of any one of clauses 19 to 30, wherein at least one of the secondary liquid chamber cover and the sonicator cover are ultrasonically welded to the atomisation module housing.
32. The atomisation module and liquid container of any one of clauses 19 to 31, wherein the sonicator assembly further comprises: a sonicator case surrounding at least part of a periphery of the ultrasonic transducer and, the sonicator case being in electrical contact with a first electrical contact on the ultrasonic transducer; a sonicator holder attached to the sonicator case; a connection pin having an end which is in electrical contact with a second electrical contact on the ultrasonic transducer; and a sleeve electrically insulating the connection pin from the sonicator holder.
33. The atomisation module and liquid container of clause 32, wherein the end of the connection pin is substantially planar.
34. A hookah comprising: a body; a suction pipe having a first end and a second end, a mouthpiece being provided at the second end; and the atomisation module and liquid container of any one of clauses 19 to 33, wherein the hookah attachment is carried by the body and the mist outlet of the atomisation module is in fluid communication with the first end of the suction pipe.
35. A hookah comprising: a water chamber; an elongate stem having a first end which is attached to the water chamber; a suction pipe having a first end attached to the water chamber and a second end, a mouthpiece being provided at the second end; and an atomisation module and liquid container according to any one of clauses 19 to 33, wherein the hookah attachment is attached to a second end of the stem, and a mist flow path extends from the mist outlet of the atomisation module, through the stem, through the suction pipe and out of the mouthpiece for inhalation by a user.
36. The hookah of clause 35, wherein the hookah attachment is detachable from the stem to enable the atomisation module and liquid container to be removed from the stem and replaced.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a diagrammatic view of a mist inhaler of some examples of this disclosure.

FIG. 2 is a diagrammatic view of an atomisation module and liquid container of some examples of this disclosure.

FIG. 3 is a cross-sectional view of a liquid container of some examples of this disclosure.

FIG. 4 is a diagrammatic view of a liquid container of some examples of this disclosure.

FIG. 5 is a diagrammatic view of an atomisation module of some examples of this disclosure.

FIG. 6 is a cross-sectional view of an atomisation module of some examples of this disclosure.

FIG. 7 is a diagrammatic view of an atomisation module of some examples of this disclosure.

FIG. 8 is a cross-sectional view of an atomisation module of some examples of this disclosure.

FIG. 9 is a diagrammatic view of an atomisation module of some examples of this disclosure.

FIG. 10 is a cross-sectional view of an atomisation module of some examples of this disclosure.

FIG. 11 is a diagrammatic view of a liquid flow guide of some examples of this disclosure.

FIG. 12 is an exploded view of a sonicator assembly of some examples of this disclosure.

FIG. 13 is a diagrammatic view of a sonicator assembly of some examples of this disclosure.

FIG. 14 is a diagrammatic view of an atomisation module of some examples of this disclosure.

FIG. 15 is a diagrammatic view of an atomisation module of some examples of this disclosure.

FIG. 16 is a cross-sectional view of an atomisation module of some examples of this disclosure.

FIG. 17 is a cross-sectional view of an atomisation module and liquid container of some examples of this disclosure.

FIG. 18 is a cross-sectional view of an atomisation module and liquid container of some examples of this disclosure.

### DETAILED DESCRIPTION OF THE DISCLOSURE

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

The following disclosure provides many different embodiments, or examples, for implementing different features of the subject matter provided. Specific examples of components, concentrations, applications and arrangements are described below to simplify the present disclosure. These are, of course, merely examples and are not intended to be limiting. For example, the attachment of a first feature and a second feature in the description that follows may include embodiments in which the first feature and the second feature are attached in direct contact, and may also include embodiments in which additional features may be positioned between the first feature and the second feature, such that the first feature and the second feature may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The following disclosure describes representative arrangements or examples. Each arrangement or example may be considered to be an embodiment and any reference to an “arrangement” or an “example” may be changed to “embodiment” in the present disclosure.

Conventional electronic vaporizing inhalers tend to rely on inducing high temperatures of a metal component configured to heat a liquid in the inhaler, thus vaporizing the liquid that can be breathed in. The liquid typically contains nicotine and flavorings blended into a solution of propylene glycol (PG) and vegetable glycerin (VG), which is vaporized via a heating component at high temperatures. Problems with conventional inhalers may include the possibility of burning metal and subsequent breathing in of the metal along with the burnt liquid. In addition, some may not prefer the burnt smell or taste caused by the heated liquid.

It is noted that the expression “mist” used in the following disclosure means the liquid is not heated as usually in traditional inhalers known from the prior art. In fact, traditional inhalers use heating elements to heat the liquid above its boiling temperature to produce a vapor, which is different from a mist.

When sonicating liquids at high intensities, the sound waves that propagate into the liquid media result in alternating high-pressure (compression) and low-pressure (rarefaction) cycles, at different rates depending on the frequency. During the low-pressure cycle, high-intensity ultrasonic waves create small vacuum bubbles or voids in the liquid. This phenomenon is termed cavitation. When the bubbles attain a volume at which they can no longer absorb energy, they collapse violently during a high-pressure cycle. During the implosion, very high pressures are reached locally. At cavitation, broken capillary waves are generated, and tiny droplets break the surface tension of the liquid and are quickly released into the air, taking mist form.

The following will explain more precisely the cavitation phenomenon.

When the liquid is atomized by ultrasonic vibrations, micro water bubbles are produced in the liquid.

The bubble production is a process of formation of cavities created by the negative pressure generated by intense ultrasonic waves generated by the means of ultrasonic vibrations.

High intensity ultrasonic sound waves leading to rapid growth of cavities with relatively low and negligible reduction in cavity size during the positive pressure cycle.

Ultrasound waves, like all sound waves, consist of cycles of compression and expansion. When in contact with a liquid, compression cycles exert a positive pressure on the liquid, pushing the molecules together. Expansion cycles exert a negative pressure, pulling the molecules away from another.

Intense ultrasound waves create regions of positive pressure and negative pressure. A cavity can form and grow during the episodes of negative pressure. When the cavity attains a critical size, the cavity implodes.

The amount of negative pressure needed depends on the type and purity of the liquid. For truly pure liquids, tensile strengths are so great that available ultrasound generators cannot produce enough negative pressure to make cavities. In pure water, for instance, more than 1,000 atmospheres of negative pressure would be required, yet the most powerful ultrasound generators produce only about 50 atmospheres of negative pressure. The tensile strength of liquids is reduced by the gas trapped within the crevices of the liquid particles. The effect is analogous to the reduction in strength that occurs from cracks in solid materials. When a crevice filled with gas is exposed to a negative-pressure cycle from a sound wave, the reduced pressure makes the gas in the crevice expand until a small bubble is released into solution.

However, a bubble irradiated with ultrasound continually absorbs energy from alternating compression and expansion cycles of the sound wave. These cause the bubbles to grow and contract, striking a dynamic balance between the void inside the bubble and the liquid outside. In some cases, ultrasonic waves will sustain a bubble that simply oscillates in size. In other cases, the average size of the bubble will increase.

Cavity growth depends on the intensity of sound. High-intensity ultrasound can expand the cavity so rapidly during the negative-pressure cycle that the cavity never has a chance to shrink during the positive-pressure cycle. In this process, cavities can grow rapidly in the course of a single cycle of sound.

For low-intensity ultrasound the size of the cavity oscillates in phase with the expansion and compression cycles. The surface of a cavity produced by low-intensity ultrasound is slightly greater during expansion cycles than during compression cycles. Since the amount of gas that diffuses in or out of the cavity depends on the surface area, diffusion into the cavity during expansion cycles will be slightly greater than diffusion out during compression cycles. For each cycle of sound, then, the cavity expands a little more than it shrinks. Over many cycles the cavities will grow slowly.

It has been noticed that the growing cavity can eventually reach a critical size where it will most efficiently absorb energy from the ultrasound. The critical size depends on the frequency of the ultrasound wave. Once a cavity has experienced a very rapid growth caused by high intensity ultrasound, it can no longer absorb energy as efficiently from the sound waves. Without this energy input the cavity can no longer sustain itself. The liquid rushes in and the cavity implodes due to a non-linear response.

The energy released from the implosion causes the liquid to be fragmented into microscopic particles which are dispersed into the air as mist.

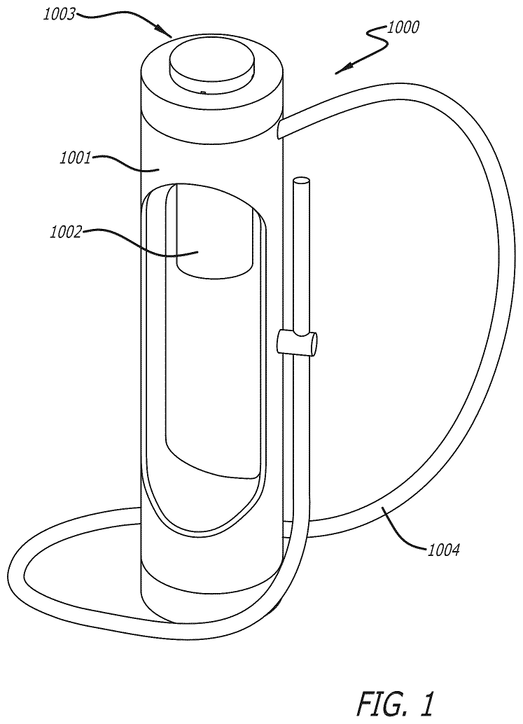

FIG. 1 shows a mist inhaler 1000 according to some embodiments of the present disclosure. The mist inhaler 1000 comprises a main body 1001, a lower vessel 1002, a mist inhalation device (or head) 1003 and a suction pipe 1004. The main body 1001 serves to support the other components of the mist inhaler 1000. The mist inhalation device 1003 is configured to generate a mist and transport the mist through the suction pipe 1004 to a user.

In some examples, the mist inhaler 1000 is a hookah or shisha which generates a mist for inhalation by a user via the suction pipe 1004 and a mouthpiece provided at the end of the suction pipe 1004. The hookah may comprise a water chamber or bowl through which mist is drawn as a user draws on the mouthpiece of the suction pipe 1004.

In other examples, the mist inhaler 1000 is a mist generating device that takes a different form or shape to a conventional hookah or shisha, and the mist inhaler 1000 may be more compact and/or portable or handheld. In these examples, the suction pipe 1004 may be omitted and a mouthpiece instead provided on the mist inhalation device 1003 so that a user can inhale mist through the mouthpiece. In these examples, the mist inhaler 1000 may take the form of a vape device or electronic cigarette.

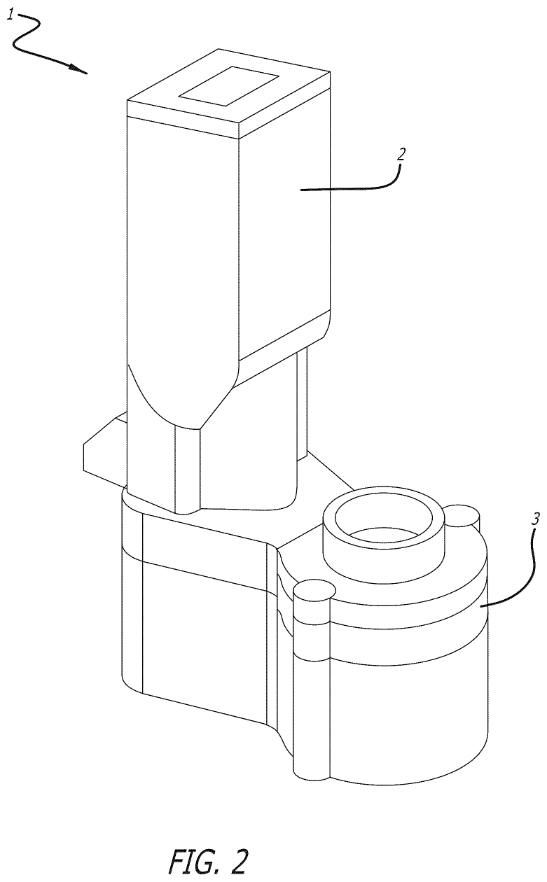

Referring now to FIG. 2 of the accompanying drawings, an atomisation module and liquid container 1 of some examples of this disclosure comprises a liquid container 2 and an atomisation module 3. The atomisation module and liquid container 1 is configured to be coupled to or at least partly positioned within a mist inhaler or mist inhalation device, such as the mist inhaler 1000 or the mist inhalation device 1003 shown in FIG. 1.

The liquid container 2 may be releasably attached to the atomisation module 3, as shown in FIG. 2. When the liquid container 2 is attached to the atomisation module 3, the liquid container 2 is in fluid communication with the atomisation module 3.

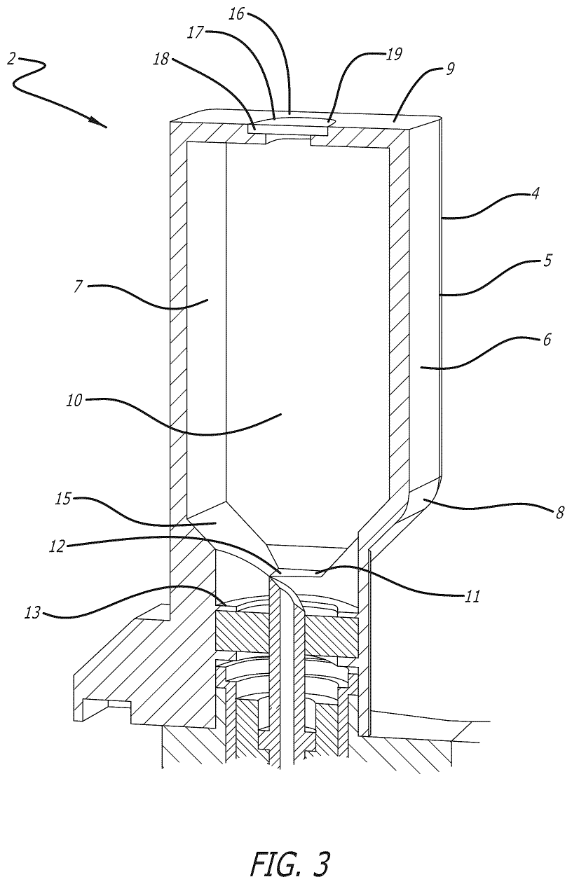

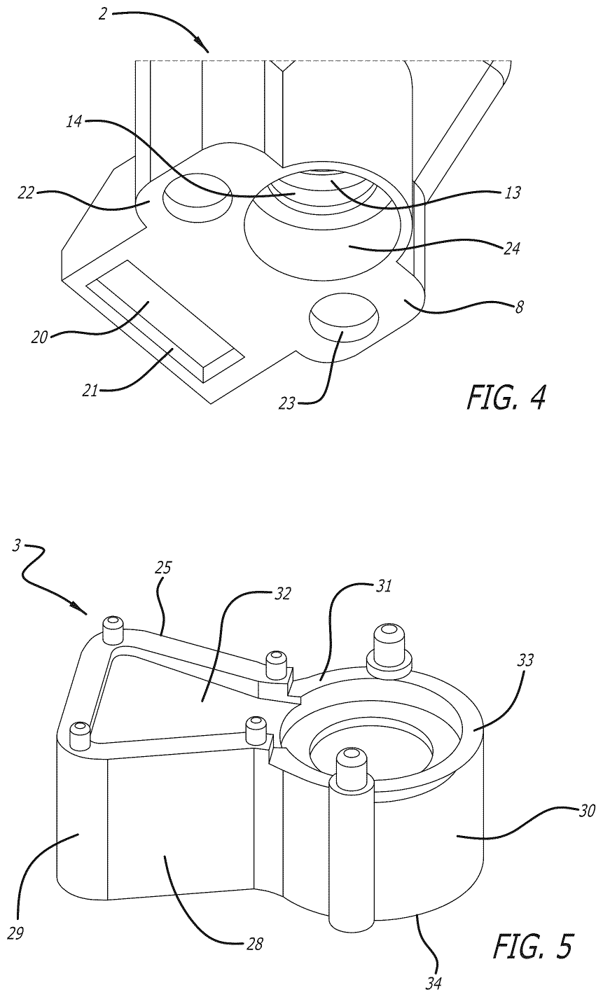

Referring now to FIGS. 3 and 4 of the accompanying drawings, the liquid container 2 comprises a liquid container housing 4. The liquid container housing 4 may comprise a liquid container body 5. The liquid container body 5 may be substantially cuboid in shape. The liquid container body 5 may comprise a liquid container exterior surface 6, a liquid container interior surface 7, a liquid container first end 8 and a liquid container second end 9. The liquid container second end 9 may be spaced apart from the liquid container first end 8 along a longitudinal axis of the liquid container body 5. The liquid container interior surface 7 defines an interior volume to form a liquid chamber 10 which is configured to contain a liquid.

The liquid may comprise nicotine and/or flavourings. The liquid may comprise a mixture of propylene glycol (PG) and vegetable glycerin (VG). The liquid may have a liquid viscosity of 1.05 Pa·s to 1.412 Pa·s.

The liquid container housing 4 may further comprise a liquid outlet 11 which is formed by an aperture in fluid communication with the liquid chamber 10. The liquid outlet 11 may be formed in the liquid container first end 8. The liquid outlet 11 may comprise a liquid seal arrangement 12 which is configured to seal or substantially seal the liquid outlet 11 and minimise or prevent the liquid stored in the liquid chamber 10 from leaking through the liquid outlet 11. The liquid seal arrangement 12 may comprise a liquid seal holder 13 and a liquid seal 14, where the liquid seal holder 13 is configured to receive the liquid seal 14. When the liquid container 2 is in use, the liquid seal arrangement 12 may be manipulated to allow the liquid to flow out from the liquid chamber 10 through the liquid outlet 11. For example, when the liquid container 2 is in use, the liquid seal 14 may be pierced or removed to allow the liquid to flow out from the liquid chamber 10 through the liquid outlet 11. The liquid seal 14 provides a cost effective and reliable method of sealing the liquid outlet. The liquid seal arrangement 12 may comprise a valve or a door which may be opened, closed or partially opened or closed.

The liquid container interior surface 7 may comprise a liquid guide surface 15. The liquid guide surface 15 may be proximate to the liquid container first end 8. The liquid guide surface 15 may be angled to form a funnel portion which reduces a cross-section area of the liquid chamber towards the liquid outlet 11. The angled shape of the liquid guide surface 15 allows the liquid to flow down towards the liquid outlet 11 and reduces the amount residual liquid left in the liquid chamber 10 when the liquid container 2 is becoming depleted.

The liquid container housing 4 may further comprise an air inlet 16 which is formed by an aperture that is in fluid communication with the liquid chamber 10. The air inlet 16 may be formed in the liquid container second end 9. The air inlet 16 may comprise an air inlet seal arrangement 17 which seals the air inlet 16. The air inlet seal arrangement 17 may comprise an air seal holder 18 and an air seal 19, where the air seal holder 18 is configured to hold the air seal 19. The air seal holder 18 may be configured to prevent unauthorised tampering of the air seal 19. When the liquid container 2 is in use, the air inlet seal arrangement 17 may be manipulated, pierced or removed to allow air to flow through the air inlet 16. In other examples the air inlet seal arrangement 17 may comprise a valve or a door which may be opened, closed or partially opened or closed. The liquid container 2 may be stored for a prolonged period of time without the liquid deteriorating or leaking since the air inlet seal arrangement 17 and the liquid seal arrangement 12 seal the liquid chamber 10.

The liquid container 2 may further comprise an identification arrangement 20 that is configured to receive and transmit signals from a driver device when the liquid container 2 is coupled to the atomisation module 3. The identification arrangement 20 may comprise an integrated circuit having a memory which stores a unique identifier for the liquid container 2. The identification arrangement 20 may further comprise an electrical connection which provides an electronic interface for communication with the driver. The identification arrangement 20 may only allow genuine liquid containers 2 from the manufacturer to be used with the atomisation module 3. This anti-counterfeiting measure may be implemented in the liquid container 2 as a specific custom integrated circuit (IC) that is bonded to the liquid container 2. The identification arrangement 20 may be received within a recess 21 in the liquid container exterior surface 6 of the liquid container first end 8. The IC contains truly unique information that allows complete traceability of liquid container 2 (and its contents) over its lifetime as well as a precise monitoring of the consumption by a user. The IC allows the atomisation module 3 to function and to generate mist only when authorized.

The unique information can be read by a driver device to ascertain information such as whether the liquid container 2 is a genuine and/or certified, and whether the liquid container 2 has been previously fully discharged, and therefore possibly refilled with counterfeit liquid. If certain conditions are met or not met, then the driver device may allow or prevent the use of the liquid container 2 with the atomisation module 3.

The liquid container 2 may further comprise a liquid container attachment 22 which is configured to attach the liquid container 2 to the atomisation module 3. The liquid container attachment 22 may be configured to enable the liquid container 2 to be releasably attached to the atomisation module 3. The liquid container attachment 22 may comprise a magnetic interface 23 which is positioned on the liquid container exterior surface 6 proximate to the liquid container first end 8. The magnetic interface 23 may comprise a magnet or of a ferromagnetic material which is not magnetised. In other examples, the liquid container attachment 22 may comprise a resiliently deformable clip or a movable locking mechanism. The liquid container attachment 22 may further comprise a liquid container connection surface 24. The liquid container attachment 22 may be a cylindrical inner surface proximate to the liquid container first end 8. When the liquid chamber 2 is depleted of liquid, the liquid container 2 may be detached from the atomisation module 3 and replaced.

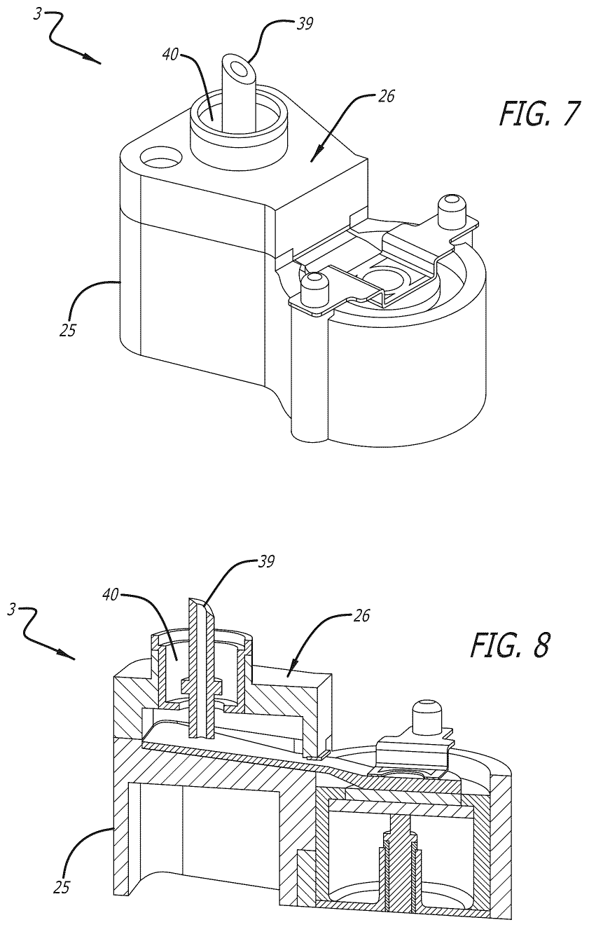

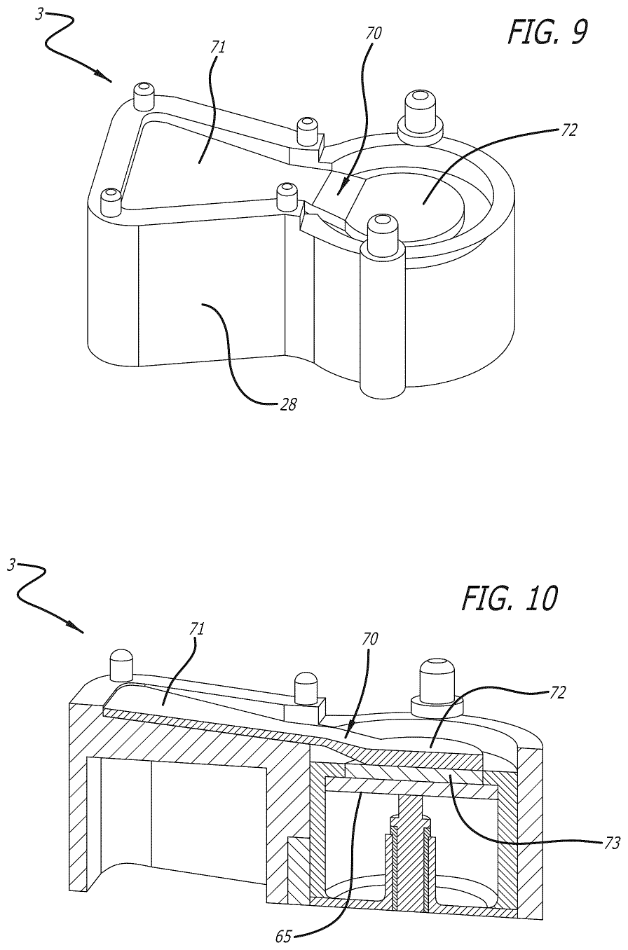

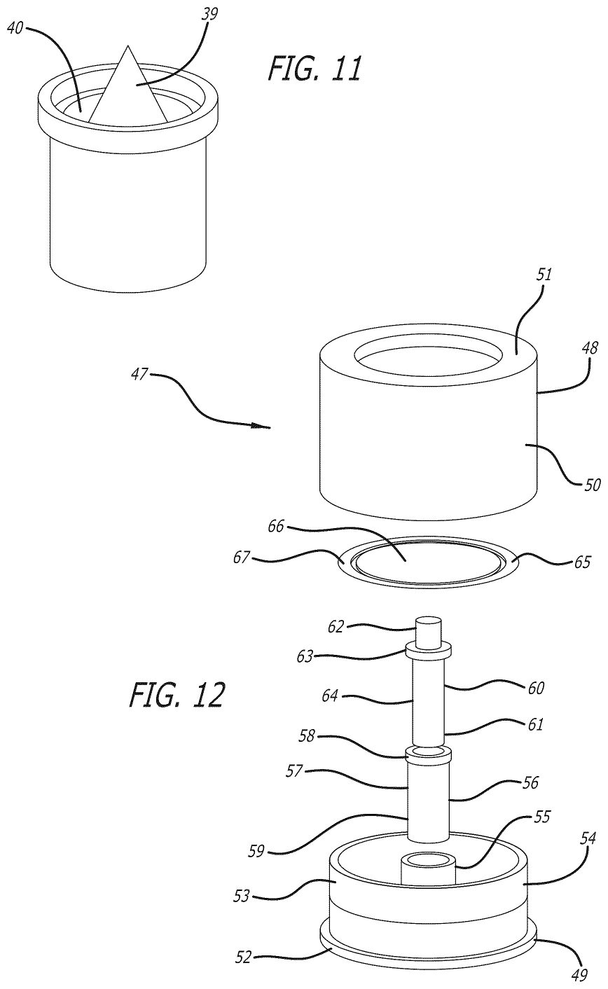

Referring now to FIGS. 5 to 11 of the accompanying drawings, the atomisation module 3 may comprise an atomisation module housing 25, a secondary liquid chamber cover 26 and a sonicator cover 27. The atomisation module housing 25 may be formed of an atomisation module housing body 28. The atomisation module housing body 28 may be divided into an atomisation module housing first portion 29 and an atomisation module housing second portion 30. The atomisation module housing body 28 may comprise a continuous atomisation module housing side wall 31. The atomisation module housing side wall 31 may have a substantially circular profile in the atomisation module housing second portion 30.

The atomisation module housing body 28 may further comprise a capillary guide 32. The capillary guide 32 may be a planar or substantially planar surface which is positioned in the atomisation module housing first portion 29. The capillary guide 32 may be oriented in a direction which is substantially perpendicular to the atomisation module housing side wall 31. The capillary guide 32 may be positioned proximate to an atomisation module upper side 33. The capillary guide 32 may span a gap between the atomisation module housing side wall 31. The capillary guide 32 may be angled towards an atomisation module lower side 34 when moving towards the atomisation module housing second portion 30.

The secondary liquid chamber cover 26 may comprise a secondary liquid chamber cover upper side 35 and a secondary liquid chamber cover lower side 36. The secondary liquid chamber cover 26 may be attached to the atomisation module housing 25. The liquid chamber cover 26 may alternatively be formed integrally with the atomisation module housing 25. The liquid chamber cover 26 being formed integrally with the atomisation module housing 25 may simplify the manufacturing process of the atomisation module 3.

The secondary liquid chamber cover lower side 36 may be attached to the atomisation module housing side wall 31 proximate to the atomisation module housing first portion 29 on the atomisation module upper side 33. The secondary liquid chamber cover 26 may be ultrasonically welded to the atomisation module housing 25. Ultrasonically welding the secondary liquid chamber cover 26 to the atomisation module housing 25 allows the secondary liquid chamber cover 26 to be formed separately while providing good leak-proof characteristics. In some examples, the secondary liquid chamber cover 26 is press fitted to the atomisation module housing 25. The atomisation module housing side wall 31 may comprise at least one liquid chamber cover pin 81 which is configured to be received by at least one corresponding aperture on the secondary liquid chamber cover 26.

The secondary liquid chamber cover 26 may further comprise a liquid flow guide 37 configured to receive the liquid from the liquid chamber 10. The liquid flow guide 37 may be positioned on the secondary liquid chamber cover upper side 34. The liquid chamber cover 26 may comprise an atomisation module attachment 38 which is configured to attach to the liquid container attachment 22 to attach the liquid container 2 to the atomisation module 3. The atomisation module attachment 38 may be a cylindrical outer surface having diameter substantially the same as a diameter of the liquid container connection surface 24. If the diameter of the atomisation module attachment 38 is substantially the same as the diameter of the liquid container connection surface 24, the liquid container 2 may be attached to the atomisation module 3 by a push fit. The atomisation module attachment 38 may further comprise a magnet or a ferromagnetic material which is configured to couple magnetically to the magnetic interface 23 of the liquid container attachment 22. The magnetic interface 23 securely attaches the liquid container 2 to the atomisation module 3. A user may also conveniently detach the liquid container 2 from the atomisation module 3 without the use of tools. In some examples, the atomisation module attachment 38 is provided on the liquid flow guide.

The liquid flow guide 37 may comprise a liquid container opener 39 which is configured to extend through the liquid outlet 11 at least party into the liquid chamber 10. The liquid container opener 39 may be configured to interact with the air inlet seal arrangement 17 to allow liquid to flow out from the liquid chamber 10 through the liquid outlet 11. The liquid container opener 39 may be configured to pierce the liquid seal 14 to open the liquid outlet 11. The liquid container opener 39 may comprise a sharp conical point. The sharp conical point may provide a suitable angled surface for the liquid to flow down while reducing any spillage of the liquid. In some examples, the liquid container opener 39 comprises a hollow needle. The hollow needle may provide an enclosed passage for the liquid to flow down while reducing any spillage of the liquid.

In examples such as those where the liquid seal arrangement 12 is a valve, the liquid container opener 39 may comprise a flat pin configured to open the valve. By using a valve for the liquid seal arrangement 12, the liquid outlet 11 may be sealed when the liquid container 2 is removed from the atomisation module 3 and allow the liquid container 2 to be reused if it is not empty.

The liquid container opener 39 may further comprise a liquid collector 40 which is configured to collect an amount of liquid which may flow out of the liquid container 2. In examples where the liquid container opener 39 comprises a sharp conical point or a hollow needle, a longitudinal length of the sharp conical point or the hollow needle may be less than a longitudinal length of the liquid collector 40. The longitudinal length of the liquid collector 40 being less than that of the sharp conical point or the hollow needle allows the liquid collector 40 to partially enclose the sharp conical point or the hollow needle and limit the chance of injury to a user.

The liquid flow guide 37 may be a separate component to the atomisation module housing 25 and the secondary liquid chamber cover 26, and be attached to the secondary liquid chamber cover 26. The liquid flow guide 37 may be press fitted in to a liquid flow guide aperture 41 formed in the secondary liquid chamber cover 26. The liquid flow guide 37 may be replaced if it is damaged or blocked.

A volume between the capillary guide 32 and the secondary liquid chamber cover lower side 36 may form a secondary liquid chamber 42. The secondary liquid chamber 42 may be substantially enclosed by the capillary guide 32 and the secondary liquid chamber cover lower side 36. The secondary liquid chamber 42 may comprise a liquid flow aperture 43 which is configured to receive the liquid from the liquid chamber when the liquid container 2 is attached to the atomisation module 3. The liquid flow aperture 43 may provide a liquid flow path from the liquid flow aperture 43 to the secondary liquid chamber 42 when the liquid container 2 is attached to the atomisation module 3. The liquid may flow from the liquid collector 40 through the liquid flow aperture 43 to the secondary liquid chamber. The liquid flow aperture 43 may be an aperture formed in the liquid collector 40. In some examples, the liquid flow aperture 43 is an aperture formed in the secondary liquid chamber cover 26 which is proximate to the liquid flow guide 37.

When the liquid container 2 is attached to the atomisation module 3, the atomisation module attachment 38 may attach to the liquid container connection surface 24 with a push fit connection. The liquid container opener 39 then pierces the liquid seal 14 or opens the liquid seal arrangement 12, allowing the liquid to flow out from the liquid chamber 10 through the liquid outlet 11 and on to the liquid collector 40. The air inlet seal arrangement 17 may be pierced, opened or removed to allow air to displace the fluid flowing out through the liquid outlet 11. In some examples, liquid may only flow out through the liquid outlet 11 when the air inlet seal arrangement 17 is pierced, opened or removed. The liquid then enters the secondary liquid chamber 42 through the liquid flow aperture 43.

The secondary liquid chamber 42 may further comprise a secondary liquid chamber outlet 44. The secondary liquid chamber outlet 44 may be an aperture formed between the secondary liquid chamber cover lower side 36 and the atomisation module housing body 28. In some examples, the secondary liquid chamber outlet 44 comprises an aperture formed only in the secondary liquid chamber cover lower side 36 or the atomisation module housing body 28. The secondary liquid chamber outlet 44 may provide a fluid connection between the secondary liquid chamber 42 and the atomisation module housing second portion 30. The angle of the capillary guide 32 encourages the liquid to flow towards the secondary liquid chamber outlet 44 and to the atomisation module housing second portion 30.

The sonicator cover 27 may comprise a sonicator cover upper side 45 and a sonicator cover lower side 46. The sonicator cover 27 may be attached to the atomisation module housing 25. The sonicator cover 27 may alternatively be formed integrally with the atomisation module housing 25. The sonicator cover 27 being formed integrally with the atomisation module housing 25 may simplify the manufacturing process of the atomisation module 3.

The sonicator cover lower side 46 may be attached to the atomisation module housing side wall 31 proximate to the atomisation module housing second portion 30 on the atomisation module upper side 33. The sonicator cover 27 may be ultrasonically welded to the atomisation module housing 25. Ultrasonically welding the sonicator cover 27 to the atomisation module housing 25 allows the sonicator cover 27 to be formed separately while providing good leak-proof characteristics. In some examples, the sonicator cover 27 is press fitted to the atomisation module housing 25.

In some examples, the atomisation module housing 25, secondary tank cover 26, the sonicator cover 27 is manufactured as a single component. In some examples, the atomisation module housing 25, secondary tank cover 26, the sonicator cover 27 is manufactured by injection moulding, 3D printing or machining. In some examples, the atomisation module may comprise a plurality of atomisation module attachment 38 which are each configured to receive a respective liquid container 2.

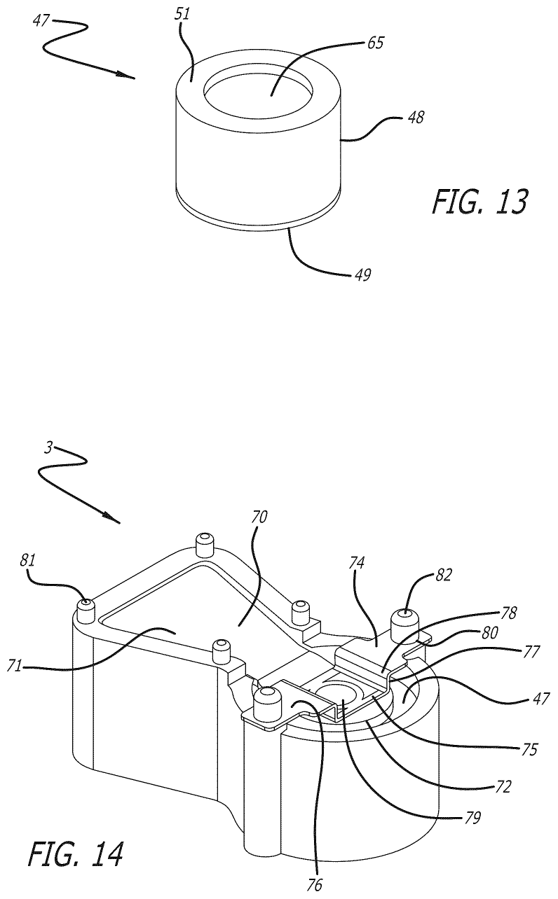

Referring now to FIGS. 12 and 13 of the accompanying drawings, the atomisation module 3 may further comprise a sonicator assembly 47. The sonicator assembly 47 may comprise a substantially cylindrical sonicator case 48 and a sonicator holder 49.

The sonicator case 48 may be formed of a tubular sonicator case body 50 having an inner diameter and an outer diameter. The sonicator case body 50 may comprise a retaining lip 51. The retaining lip 51 may be formed by an inward radial protrusion extending at least partially around the circumference of one end of the sonicator case body 50. The sonicator case 48 may further comprise a first thread formed on an inner surface of the tubular sonicator case body 50. In some examples, the sonicator case 48 does not comprise a thread. The sonicator case 48 may be of brass. In some examples, the sonicator case 48 is of any other electrically conductive metal material.

The sonicator holder 49 may be formed of a base plate 52 having a circular profile. The sonicator holder 49 may further comprise a raised collar 53 which extends at a location proximate to an outer edge of the base plate 52. The raised collar 53 may have a circular profile and an inner and an outer diameter. The sonicator holder 49 may further comprise a second thread formed on a raised collar outer surface 54 which is configured to engage with the first thread of the sonicator case 48 such that the sonicator case 48 may be attached to the sonicator holder 49. A threaded attachment between the sonicator case 48 and the sonicator holder 49 allows the sonicator assembly to be easily assembled during manufacture and easily disassembled if components must be replaced. In some examples, the sonicator holder 49 does not comprise a thread and the sonicator case 48 may instead be press fitted to the sonicator holder 49 or attached to the sonicator holder 49 by an adhesive. The base plate 52 may be of brass. In some examples, the base plate 52 is of any other electrically conductive metal material.

The circular base plate 52 may further comprise a central support 55. The central support 55 may from a central location of the base plate 52. The central support 55 may have a circular profile with an inner diameter and an outer diameter that is less than the respective inner diameter and outer diameter of the raised collar 53.

The sonicator assembly 47 may further comprise a sleeve 56 having a substantially tubular sleeve body 57 which has an inner diameter and an outer diameter. The sleeve 56 may comprise a first sleeve outer diameter and a second sleeve outer diameter. The first sleeve outer diameter may be greater than the second sleeve outer diameter. The first sleeve outer diameter may extend longitudinally along a sleeve first portion 58 and the second sleeve outer diameter extends longitudinally along a sleeve second portion 59. The sleeve second portion 59 may have a greater longitudinal length than the sleeve first portion 58. The sleeve 56 may be of a non-electrically conductive material. The sleeve 56 may be of a resiliently deformable material. The sleeve 56 may be of a silicone material. In some examples, the sleeve 56 is of a plastic material. In some examples, the sleeve 56 is of a thermally insulating material.

The second sleeve outer diameter may be sized such that the sleeve second portion 59 fits into an inner diameter of the central support 55. The sleeve first portion 58 may contact the central support 55.

The sonicator assembly 47 may further comprise a connection pin 60. The connection pin 60 may have a substantially cylindrical pin body 61 comprising a first pin diameter, a second pin diameter and a third pin diameter. The second pin diameter may be greater than the third pin diameter. The first pin diameter may be less than the third pin diameter. In some examples, the relationships between the first pin diameter, the second pin diameter and the third pin diameter may be different. In some examples, the second pin diameter is equal to the first sleeve outer diameter.

The first pin diameter may extend longitudinally along a first pin portion 62, the second pin diameter may extend longitudinally along a second pin portion 63 and the third pin diameter may extend longitudinally along a third pin portion 64. The second pin portion 63 may be positioned between the first pin portion 62 and the third pin portion 64. The first pin portion 62 may have a shorter longitudinally length than the third pin portion 64. The second pin portion 63 may have a shorter longitudinally length than the first pin portion 62. In some examples, the first pin portion 62, the second pin portion 63 and the third pin portion 64 may be of different lengths.

The third pin diameter may be sized such that the third pin portion 64 fits into the inner diameter of the sleeve 56. The pin second portion 62 may contact the sleeve 56. An end of the cylindrical pin body 61 may be flat.

The sonicator assembly 47 may further comprise an ultrasonic transducer 65. The ultrasonic transducer 65 may be disc-shaped or substantially disc-shaped. The ultrasonic transducer 65 may have a planar or substantially planar upper surface and a planar or substantially planar lower surface. The ultrasonic transducer 65 may have a glass coating on at least part of the upper surface. The ultrasonic transducer 65 may have an electrode contact on the lower surface. The ultrasonic transducer 65 may have a circular profile. In some examples, the ultrasonic transducer 65 has a non-circular profile.

The ultrasonic transducer 65 may comprise a first electrical contact 66 and a second electrical contact 67. The second electrical contact 67 may be proximate to an outer edge of the ultrasonic transducer 65 and the first electrical contact 66 may be a central part of the ultrasonic transducer 65. The ultrasonic transducer 65 may have an outer diameter which is substantially equal to the inner diameter of the sonicator case body 50. The sonicator case body 50 may surround at least part of a periphery of the ultrasonic transducer 65.

When the sonicator assembly 47 is assembled, the sleeve second portion 59 may be inserted into the central support 55. The third pin portion 64 may be inserted into the sleeve 56 inner diameter. The first thread of the sonicator case 48 may engage with the second thread formed on the raised collar outer surface 54 to attach the sonicator case 48 to the sonicator holder 49 and assemble the sonicator assembly 47.

When the sonicator assembly 47 is assembled, the connection pin 60 may be in contact with the lower surface of ultrasonic transducer 65 in the first electrical contact 66. The retaining lip 51 may be in contact with the upper surface of ultrasonic transducer 65 in the second electrical contact 67. The contact between the connection pin 60 and the first electrical contact 66, and the contact between the retaining lip 51 and the second electrical contact 67, may each form an electrical connection between the contacting parts. The retaining lip 51 conveniently secures the ultrasonic transducer 65 while providing an electrical connection with the second electrical contact 67. The sleeve 56 being of a resiliently deformable material allows the connection pin 60 to be biased toward the first electrical contact 66 and ensures a reliable electrical connection. The sleeve 56 being of a thermally insulating material prevents heat from the ultrasonic transducer 65 from being transmitted to the sonicator holder 49.

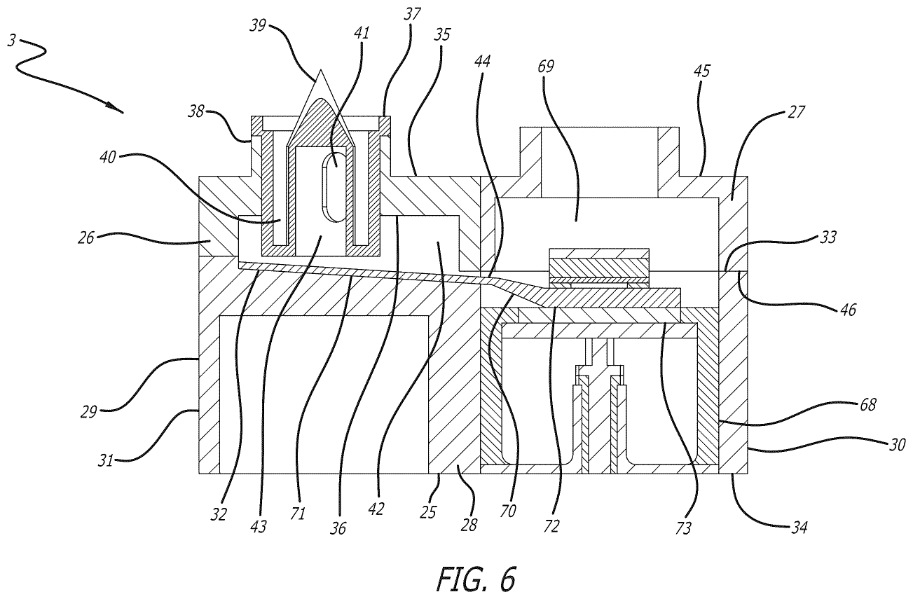

Referring again to FIG. 6 of the accompanying drawings, the atomisation module housing second portion 30 may comprise a sonicator assembly holder 68 which is configured to receive the sonicator assembly 47. The sonicator assembly 47 may be releasably attached to the sonicator assembly holder 68. The sonicator assembly 47 may then be replaced if any components of the sonicator assembly 47 fail. The sonicator assembly holder 68 may be formed of a cylindrical bore. The cylindrical bore may have an inner diameter which is substantially equal to the outer diameter of the sonicator case body 50. The sonicator assembly holder 68 may be formed in the atomisation module housing second portion 30. A sonication chamber 69 may be formed in the volume between the sonicator assembly 47 and the sonicator cover 27.

The atomisation module 3 may further comprise a first capillary 70 which is configured to transfer liquid from the secondary liquid chamber 42 to the sonication chamber 69. The first capillary 70 may be substantially planar and may comprise a first capillary first portion 71 and a first capillary second portion 72. The first capillary first portion 71 may have a profile which is configured to be surrounded by the atomisation module housing side wall 31 at the atomisation module housing first portion 29. The first capillary second portion 72 may have a substantially round profile.

The atomisation module 3 may further comprise a second capillary 73 which is configured to transfer liquid from the first capillary 70 to the upper surface of the ultrasonic transducer 65. The second capillary 73 may be positioned in the sonication chamber 69. The second capillary 73 may be substantially planar and have a profile which is configured to be surrounded by the retaining lip 51 of the sonicator case 48. The second capillary 73 may have a second capillarity (liquid flow rate) which is lower than a first capillarity of the first capillary 70. The first capillarity being higher allows the first capillary 70 to quickly wick liquid from the secondary liquid chamber 42 to the second capillary 73. The lower second capillarity minimises or prevents the second capillary 73 from delivering excess liquid to the ultrasonic transducer 65.

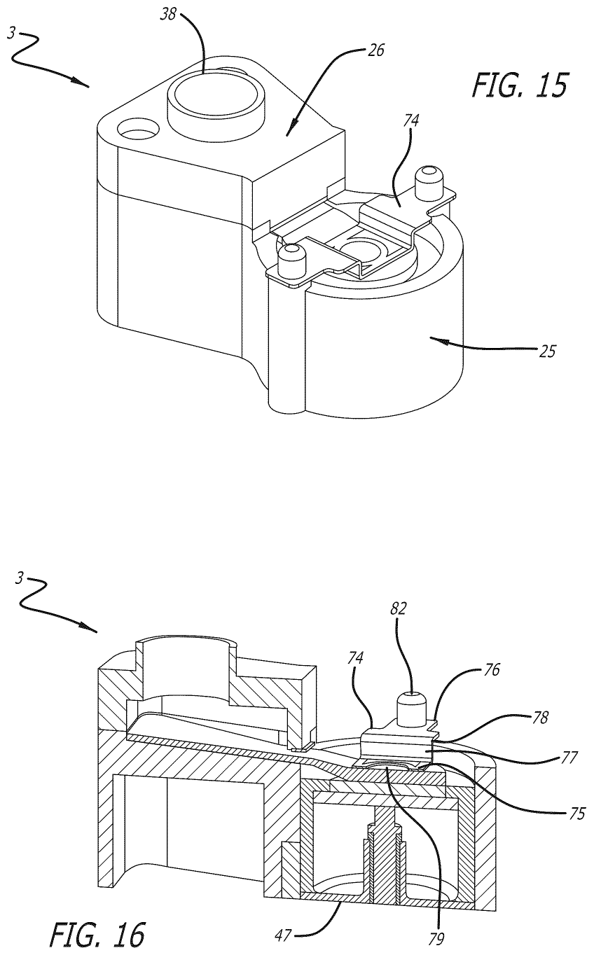

Referring now to FIGS. 14 to 16 of the accompanying drawings, the atomisation module 3 may further comprise a resiliently deformable compression body 74 which is configured to apply a biasing force to bias the first capillary 70 against the second capillary 73. The resiliently deformable compression body 74 may be configured to bias the second capillary 73 against the sonicator assembly 47. The resiliently deformable compression body 74 may comprise a compression body contact portion 75 and a compression body fastening portion 76. The resiliently deformable compression body 74 may further comprise a compression body adjustment arrangement 77 which may be manipulated to adjust the biasing force applied by the resiliently deformable compression body 74. This adjustment of the biasing force allows the resiliently deformable compression body 74 to be adapted to different atomisation module geometries and configurations.

The resiliently deformable compression body 74 of this example of the disclosure may be formed of a planar body. The planar body of the resiliently deformable compression body 74 may have a substantially rectangular profile when viewed from a top view and a U-shaped profile when viewed from a side view. The compression body contact portion 75 may be formed by a central part of the U-shaped profile and the compression body fastening portion 76 may be formed by outer parts of the U-shaped profile. The compression body adjustment arrangement 77 may be formed of vertical parts of the U-shaped profile which connects the compression body contact portion 75 to the compression body fastening portions 75. The compression body adjustment arrangement 77 may comprise a plurality of radiused edges 78 which form the U-shaped profile and connect the compression body adjustment arrangement 77 to the compression body contact portion 75 and compression body fastening portion 76. The radiused edges 78 may be modified to adjust the force applied by the resiliently deformable compression body 74.

The resiliently deformable compression body 74 may further comprise a compression body flow arrangement 79. The compression body flow arrangement 79 may be located on the compression body contact portion 75. The compression body flow arrangement 79 may be configured to allow fluid to flow from a side of the compression body contact portion 75 to an opposing side of the compression body contact portion 75, while still providing the biasing force. The compression body flow arrangement 79 may be formed by an aperture. The compression body flow arrangement 79 may be formed by a permeable material or a mesh.

The resiliently deformable compression body 74 ensures that the first capillary 70 is in contact with the second capillary 73 and that the second capillary 73 is in contact with the sonicator assembly 47. This prevents bubbling of e-liquid between the first capillary 70 and the second capillary 73.

The resiliently deformable compression body 74 may further comprise a compression body fastening arrangement 80 which is configured to attach the resiliently deformable compression body 74 to the atomisation module housing 25. The compression body fastening arrangement 80 may releasably attach the resiliently deformable compression body 74 to the atomisation module housing 25 to allow the resiliently deformable compression body 74 to be replaced. The compression body fastening arrangement 80 may comprise apertures formed in each part of the compression body fastening portion 76. The apertures may be configured to be received by corresponding compression body connecting pins 82 which are located on the atomisation module housing side wall 31 proximate to the atomisation module housing second portion 30. The compression body connecting pins 82 may be configured to be received by corresponding apertures on the sonicator cover 27.

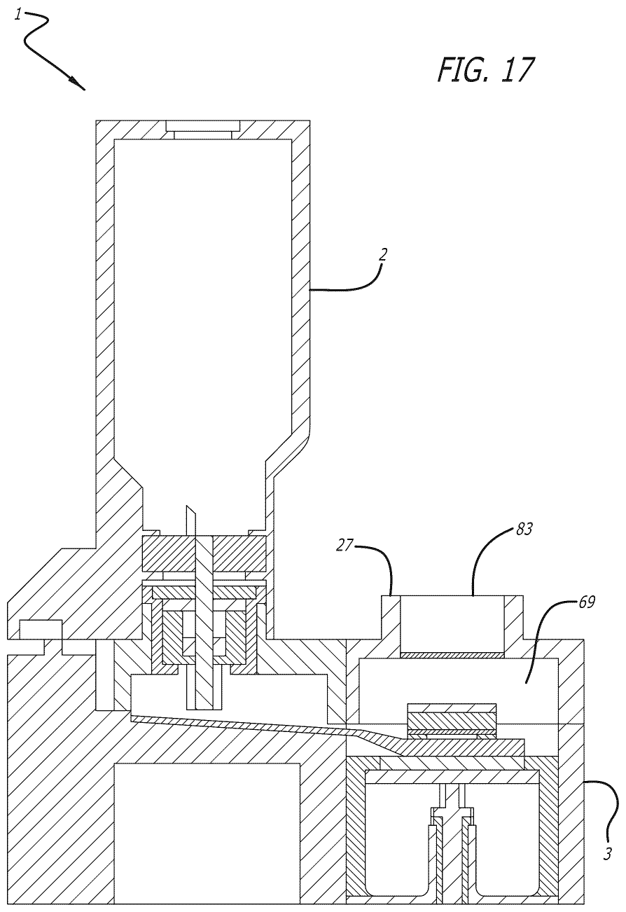

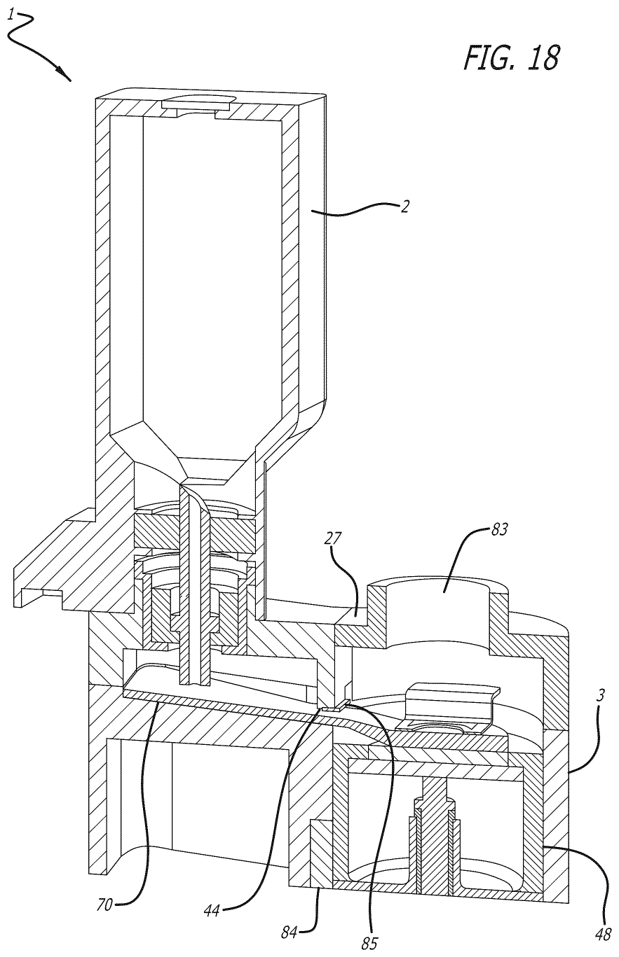

Referring now to FIGS. 17 and 18, the sonicator cover 27 may further comprise a sonication chamber outlet 83 which is configured to allow fluid or mist to flow out from the sonication chamber 69. The sonication chamber outlet 83 may be an aperture formed in the sonicator cover 27.

The sonication chamber outlet 83 may be fluidly coupled to a mist outlet of a mist inhaler. For example, the sonication chamber outlet 83 may be fluidly coupled to one end of the suction pipe 1004 of the mist inhaler 1000 shown in FIG. 1 to enable mist generated within the sonication chamber 69 to flow out from the sonication chamber 69 and through the suction pipe 1004 for inhalation by a user. In other examples, the sonication chamber outlet 83 may be fluidly coupled to a mouthpiece to enable mist generated within the sonication chamber 69 to flow out from the sonication chamber 69 and through the mouthpiece for inhalation by a user.

An air inlet (not shown) is provided in a wall of the sonication chamber 69 to allow air to flow into the sonication chamber 69 as mist and air is drawn out from the sonication chamber 69 by a user drawing on the suction pipe 1004 and/or the mouthpiece.

The atomisation module 3 may further comprise a hookah attachment which is configured to attach the atomisation module to a hookah. The hookah attachment may comprise a hookah outlet port which provides a fluid flow path from the sonication chamber outlet 83 such that when the ultrasonic transducer 65 is activated by the driver device, mist generated by the ultrasonic transducer 65 flows along the fluid flow path and out of the atomisation module 3 to the hookah.

The atomisation module 3 may further comprise a sonicator electrical contact 84 which is configured to electrically connect with the outer diameter of the sonicator case 48 when the atomisation module 3 is assembled. The sonicator electrical contact 84 may be configured to be received by a recess in the atomisation module housing body 28 proximate to the atomisation module housing second portion 30. The sonicator electrical contact 84 may be a crescent-shaped with an inner diameter which is substantially the same as the outer diameter of the sonicator case 48. The crescent-shaped sonicator electrical contact 84 provides a reliable electrical connection with the sonicator case 48. The sonicator electrical contact 84 may be of brass. In some examples, the sonicator electrical contact 84 is of any other electrically conductive metal material.

The atomisation module 3 may further comprise a secondary liquid chamber seal 85. The secondary liquid chamber seal 85 may contact the first capillary 70 at a location proximate to the secondary liquid chamber outlet 44. The secondary liquid chamber seal 85 may seal the secondary liquid chamber outlet 44. The secondary liquid chamber seal 85 may be of a resiliently deformable material. The secondary liquid chamber seal 85 may be of rubber. The liquid may still be conveyed between the secondary liquid chamber 42 and the sonication chamber 69 by the first capillary 70 but the liquid chamber seal 85 prevents excess liquid from flowing into the sonication chamber 69.

When the atomisation module 3 is assembled, the sonicator assembly 47 may be inserted into the sonicator assembly holder 68 and the second capillary 73 positioned proximate to the sonicator case 48 such that the retaining lip 51 surrounds the second capillary 73. The first capillary 70 may be positioned such that the first capillary first portion 71 is positioned in the secondary liquid chamber 42 and in contact with the capillary guide 32. The first capillary second portion 72 may be positioned in the sonication chamber 69 and in contact with the second capillary 73. The resiliently deformable compression body 74 may be attached to the atomisation module housing body 28 such that the compression body contact portion 75 is in contact with the first capillary 70 and the compression body contact portion 75 exerts a force on the first capillary 70. The secondary liquid chamber cover 26 may be attached to the atomisation module housing side wall 31 proximate to the atomisation module housing first portion 29. The sonicator cover 27 may be attached to the atomisation module housing side wall 31 proximate to the atomisation module housing second portion 30.

The above-described liquid container 2 and atomisation module 3 are configured to be coupled to a driver device which is configured to power and control the atomisation module and liquid container 1.

The driver device may house an electrical storage device configured to power the atomisation module 3 so that the driver device generates a drive signal which drives the ultrasonic transducer 65 within the atomisation module 3. The electrical storage device can be a battery, including but not limited to a lithium-ion, alkaline, zinc-carbon, nickel-metal hydride, or nickel-cadmium battery; a super capacitor; or a combination thereof. The electrical storage device may be rechargeable. In examples utilizing a rechargeable electrical storage device, a charging port may be provided so that the electrical storage device does not need to be removed from the driver device. The electrical storage device may be primarily selected to deliver a constant voltage independent of charge level. Otherwise, the performance may degrade over time. Preferred electrical storage devices that are able to provide a consistent voltage output over the life of the device include lithium-ion and lithium polymer batteries.

Electrical communication between the driver device and the ultrasonic transducer 65 may be established using the sonicator electrical contact 84 and the sonicator holder 49.

The driver device may comprise a circuit board carrying at least one integrated circuit and/or a microprocessor. In some arrangements, the at least one integrated circuit and/or the microprocessor is configured to process data from a sensor which senses a parameter indicative of the operation of the ultrasonic transducer 65 and controls the driver device to vary the drive signal output to the ultrasonic transducer 65 in a feedback loop.

In some examples, the mist inhaler or hookah comprises an AC drive signal generator coupled electrically to the ultrasonic transducer 65 to drive the ultrasonic transducer 65 with an AC drive signal to vibrate. The vibration of the ultrasonic transducer 65 atomises liquid carried by the first capillary 70 and/or the second capillary 73 to generate a mist.

In some arrangements, the atomisation module 3 or the driver device comprises an activation sensor which detects when the user draws on a mouthpiece and activates the ultrasonic transducer 65 to generate a mist. The activation sensor can be selected to detect changes in pressure, air flow, or vibration. In one arrangement, the activation sensor is a pressure sensor.

In some arrangements, the integrated circuit comprises a frequency controller which is configured to control the frequency of the drive signal output from the driver device to the ultrasonic transducer 65. The frequency controller comprises a processor and a memory, the memory storing executable instructions which, when executed by the processor, cause the processor to perform at least one function of the frequency controller.

In some arrangements, the driver device drives the ultrasonic transducer 65 with a signal having a frequency of 2.8 MHz to 3.2 MHz in order to atomize a liquid having a liquid viscosity of 1.05 Pa·s to 1.412 Pa·s. Such a frequency enables the ultrasonic transducer 65 to produce a bubble volume of about 0.25 to 0.5 microns. However, for liquids with a different viscosity or for other applications the ultrasonic transducer 65 may be driven at a different frequency. Parameters affecting the optimal frequency include the transducer manufacturing process and tolerances, the physical load on the transducer, the local and ambient temperature, and the distance from the transducer to the power source.

The driver device may have a wireless communication system, such as in the form of a Bluetooth Low Energy capable microcontroller. The wireless communication system is in communication with the at least one integrated circuit and/or the microprocessor of the device and is configured to transmit and receive data between the driver device and a computing device, such as a smartphone.

The connectivity via Bluetooth Low Energy to a companion mobile application allows for remote control of the mist inhalation device.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An atomisation module and liquid container for a hookah, the atomisation module and liquid container comprising:
a liquid container incorporating:
a liquid container housing having an air inlet, a liquid outlet and a liquid container attachment;
a liquid chamber within the liquid container housing, the liquid chamber being in fluid communication with the air inlet and the liquid outlet, the liquid chamber containing a liquid to be atomised;
an air seal which seals the air inlet;
a liquid seal which seals the liquid outlet; and
an atomisation module incorporating:
an atomisation module housing having a first portion and a second portion;
a sonication chamber;
a sonicator cover which is attached to the second portion of the atomisation module housing, the sonication chamber being formed between part of the sonicator cover and part of the second portion of the atomisation module housing, wherein the sonicator cover incorporates a mist outlet;
a secondary liquid chamber;
a secondary liquid chamber cover which is attached to the first portion of the atomisation module housing, the secondary liquid chamber being formed between part of the secondary liquid chamber cover and part of the first portion of the atomisation module housing;
an atomisation module attachment provided on the secondary liquid chamber cover, the atomisation module attachment being configured to releasably attach to the liquid container attachment to enable the liquid container to be releasably attached to the atomisation module;
a liquid flow guide provided on the secondary liquid chamber cover, the liquid flow guide incorporating:
a liquid container opener which is configured to pierce the liquid seal to open the liquid outlet and extend through the liquid outlet at least party into the liquid chamber when the liquid container is attached to the atomisation module; and
a liquid flow aperture which is configured to receive the liquid from the liquid chamber when the liquid container is attached to the atomisation module, wherein the liquid flow guide provides a liquid flow path from the liquid flow aperture to the secondary liquid chamber when the liquid container is attached to the atomisation module; the atomisation module further incorporating:
a sonicator assembly provided within the sonication chamber, the sonicator assembly having an ultrasonic transducer;
a first capillary having a first portion which is positioned in the secondary liquid chamber and a second portion which is positioned in the sonication chamber; and
a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary,
wherein, when the liquid container is attached to the atomisation module, the liquid flows out of the liquid outlet, through the liquid flow guide and into the secondary liquid chamber, and the first capillary transfers the liquid to the second capillary, and the ultrasonic transducer atomises the liquid to produce a mist, and wherein when the liquid chamber is depleted of liquid, the liquid container may be detached from the atomisation module and replaced, the atomisation module further comprising:
a hookah attachment which is configured to attach the atomisation module to a hookah with the mist outlet providing a mist flow path from the atomisation module to the hookah to enable mist produced within the sonication chamber to be drawn out from the sonication chamber through the mist outlet and through the hookah for inhalation by a user.

2. The atomisation module and liquid container of claim 1, wherein the atomisation module further comprises a capillary element guide surface provided on the first portion of the atomisation module housing, the capillary element guide surface being angled to facilitate a flow of the liquid from the secondary liquid chamber to the sonication chamber.

3. The atomisation module and liquid container of claim 1, wherein the second capillary has a lower capillarity than the first capillary.

4. The atomisation module and liquid container of claim 1, wherein the atomisation module comprises a resiliently deformable compression body configured to apply a biasing force to bias the second portion of the first capillary element against the second capillary and bias the second capillary against the ultrasonic transducer.

5. The atomisation module and liquid container of claim 4, wherein the resiliently deformable compression body comprises a compression body adjustment arrangement which may be manipulated to adjust the biasing force applied by the resiliently deformable compression body.

6. The atomisation module and liquid container of claim 1, wherein the atomisation module further comprises a secondary tank seal which contacts the first capillary and seals the secondary liquid chamber outlet.

7. The atomisation module and liquid container of claim 1, wherein the liquid container opening arrangement comprises one of a conical member and a needle which is configured to pierce the liquid seal as the liquid container is attached to the atomisation module.

8. The atomisation module and liquid container of claim 1, wherein the liquid container opening arrangement further comprises a liquid collector configured to collect liquid which flows out from the liquid container and before the liquid flows into the secondary liquid chamber.

9. The atomisation module and liquid container of claim 1, wherein the liquid container further comprises an interior liquid guide surface which is angled to form a funnel portion which reduces a cross-section area of the liquid chamber towards the liquid outlet.

10. The atomisation module and liquid container of claim 1, wherein the atomisation module is configured to be coupled to a driver device and wherein the atomisation module further comprises a sonicator electrical contact arrangement which is connected electrically to the sonicator assembly, the sonicator electrical contact arrangement being configured to receive an electrical drive signal from the driver device and to communicate the electrical drive signal to the sonicator assembly to drive the ultrasonic transducer.

11. The atomisation module and liquid container of claim 1, wherein the liquid container comprises an identification arrangement incorporating:
an integrated circuit having a memory which stores a unique identifier for the liquid container.

12. The atomisation module and liquid container of claim 1, wherein one of the liquid container attachment and the atomisation module attachment comprises a magnet and the other of the liquid container attachment and the atomisation module attachment comprises a ferromagnetic material such that the liquid container attachment and the atomisation module attachment couple magnetically to one another.

13. The atomisation module and liquid container of claim 1, wherein at least one of the secondary liquid chamber cover and the sonicator cover are ultrasonically welded to the atomisation module housing.

14. The atomisation module and liquid container of claim 1, wherein the sonicator assembly further comprises:
a sonicator case surrounding at least part of a periphery of the ultrasonic transducer and, the sonicator case being in electrical contact with a first electrical contact on the ultrasonic transducer;
a sonicator holder attached to the sonicator case;
a connection pin having an end which is in electrical contact with a second electrical contact on the ultrasonic transducer; and
a sleeve electrically insulating the connection pin from the sonicator holder.

15. The atomisation module and liquid container of claim 14, wherein the end of the connection pin is substantially planar.

16. A hookah comprising:
a body;
a suction pipe having a first end and a second end, a mouthpiece being provided at the second end; and
an atomisation module and liquid container comprising:
a liquid container incorporating:
a liquid container housing having an air inlet, a liquid outlet and a liquid container attachment;
a liquid chamber within the liquid container housing, the liquid chamber being in fluid communication with the air inlet and the liquid outlet, the liquid chamber containing a liquid to be atomised;
an air seal which seals the air inlet;
a liquid seal which seals the liquid outlet; and
an atomisation module incorporating:
an atomisation module housing having a first portion and a second portion;
a sonication chamber;
a sonicator cover which is attached to the second portion of the atomisation module housing, the sonication chamber being formed between part of the sonicator cover and part of the second portion of the atomisation module housing, wherein the sonicator cover incorporates a mist outlet;
a secondary liquid chamber;
a secondary liquid chamber cover which is attached to the first portion of the atomisation module housing, the secondary liquid chamber being formed between part of the secondary liquid chamber cover and part of the first portion of the atomisation module housing;
an atomisation module attachment provided on the secondary liquid chamber cover, the atomisation module attachment being configured to releasably attach to the liquid container attachment to enable the liquid container to be releasably attached to the atomisation module;
a liquid flow guide provided on the secondary liquid chamber cover, the liquid flow guide incorporating:
a liquid container opener which is configured to pierce the liquid seal to open the liquid outlet and extend through the liquid outlet at least party into the liquid chamber when the liquid container is attached to the atomisation module; and
a liquid flow aperture which is configured to receive the liquid from the liquid chamber when the liquid container is attached to the atomisation module, wherein the liquid flow guide provides a liquid flow path from the liquid flow aperture to the secondary liquid chamber when the liquid container is attached to the atomisation module; the atomisation module further incorporating:
a sonicator assembly provided within the sonication chamber, the sonicator assembly having an ultrasonic transducer;
a first capillary having a first portion which is positioned in the secondary liquid chamber and a second portion which is positioned in the sonication chamber; and
a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary,
wherein, when the liquid container is attached to the atomisation module, the liquid flows out of the liquid outlet, through the liquid flow guide and into the secondary liquid chamber, and the first capillary transfers the liquid to the second capillary, and the ultrasonic transducer atomises the liquid to produce a mist, and wherein when the liquid chamber is depleted of liquid, the liquid container may be detached from the atomisation module and replaced, the atomisation module further comprising:
a hookah attachment which is carried by the body the mist outlet being in fluid communication with the first end of the suction pipe and providing a mist flow path from the atomisation module to enable mist produced within the sonication chamber to be drawn out from the sonication chamber through the mist outlet and through the suction pipe for inhalation by a user.

17. A hookah comprising:
a water chamber;
an elongate stem having a first end which is attached to the water chamber;
a suction pipe having a first end attached to the water chamber and a second end, a mouthpiece being provided at the second end; and
an atomisation module and liquid container comprising:
a liquid container incorporating:
a liquid container housing having an air inlet, a liquid outlet and a liquid container attachment;
a liquid chamber within the liquid container housing, the liquid chamber being in fluid communication with the air inlet and the liquid outlet, the liquid chamber containing a liquid to be atomised;
an air seal which seals the air inlet;
a liquid seal which seals the liquid outlet; and
an atomisation module incorporating:
an atomisation module housing having a first portion and a second portion;
a sonication chamber;
a sonicator cover which is attached to the second portion of the atomisation module housing, the sonication chamber being formed between part of the sonicator cover and part of the second portion of the atomisation module housing, wherein the sonicator cover incorporates a mist outlet;
a secondary liquid chamber;
a secondary liquid chamber cover which is attached to the first portion of the atomisation module housing, the secondary liquid chamber being formed between part of the secondary liquid chamber cover and part of the first portion of the atomisation module housing;
an atomisation module attachment provided on the secondary liquid chamber cover, the atomisation module attachment being configured to releasably attach to the liquid container attachment to enable the liquid container to be releasably attached to the atomisation module;
a liquid flow guide provided on the secondary liquid chamber cover, the liquid flow guide incorporating:
a liquid container opener which is configured to pierce the liquid seal to open the liquid outlet and extend through the liquid outlet at least party into the liquid chamber when the liquid container is attached to the atomisation module; and
a liquid flow aperture which is configured to receive the liquid from the liquid chamber when the liquid container is attached to the atomisation module, wherein the liquid flow guide provides a liquid flow path from the liquid flow aperture to the secondary liquid chamber when the liquid container is attached to the atomisation module; the atomisation module further incorporating:
a sonicator assembly provided within the sonication chamber, the sonicator assembly having an ultrasonic transducer;
a first capillary having a first portion which is positioned in the secondary liquid chamber and a second portion which is positioned in the sonication chamber; and
a second capillary which is positioned in the sonication chamber in contact with the ultrasonic transducer, the second portion of the first capillary being superimposed on the second capillary and in contact with the second capillary, and the first capillary being configured to transfer the liquid from the secondary liquid chamber to the second capillary,
wherein, when the liquid container is attached to the atomisation module, the liquid flows out of the liquid outlet, through the liquid flow guide and into the secondary liquid chamber, and the first capillary transfers the liquid to the second capillary, and the ultrasonic transducer atomises the liquid to produce a mist, and wherein when the liquid chamber is depleted of liquid, the liquid container may be detached from the atomisation module and replaced, the atomisation module further comprising:
a hookah attachment which is attached to a second end of the stem, and a mist flow path extends from the mist outlet of the atomisation module, through the stem, through the suction pipe and out of the mouthpiece for inhalation by a user.

18. The hookah of claim 17, wherein the hookah attachment is detachable from the stem to enable the atomisation module and liquid container to be removed from the stem and replaced.
